(19) United States
(12) Patent Application Publication
(10) Pub. No.: US 2012/0003525 A1
(43) Pub. Date: Jan. 5, 2012

(54) SEPARATOR FOR AN ELECTRICITY STORAGE DEVICE AND METHOD OF MANUFACTURING SAME

(75) Inventors: Takeshi Hashimoto, Shizuoka-shi (JP); Hiroki Totsuka, Shizuoka (JP); Masanori Takahata, Shizuoka-shi (JP); Mitsuyoshi Takanashi, Shizuoka-shi (JP); Yasuhiro Oota, Shizuoka-shi (JP); Kazuhiko Sano, Shizuoka-shi (JP); Daisuke Tezuka, Shizuoka-shi (JP)

(73) Assignee: TOMOEGAWA CO., LTD., Tokyo (JP)

(21) Appl. No.: 13/256,321

(22) PCT Filed: Mar. 16, 2010
(86) PCT No.: PCT/JP2010/001861

§ 371 Date: Sep. 13, 2011

(30) Foreign Application Priority Data
Mar. 17, 2009 (JP) 2009064888
Mar. 17, 2009 (JP) 2009065205

(51) Int. Cl. H01M 2/16; H01G 9/00; B32B 5/26; D21H 27/30; D04H 13/00; H01M 2/18; B05D 5/12; H01G 9/155; B32B 5/02

(52) U.S. Cl. 429/144; 361/502; 361/500; 442/381; 442/335; 427/121; 442/327; 428/220; 429/254; 162/123

(57) ABSTRACT

The present invention provides a separator for an electricity storage device that is formed by superimposing two or more fiber layers, wherein at least one or more of the fiber layers is a synthetic fiber layer that contains synthetic fibers and a synthetic resin binding agent, and also provides a method of manufacturing the same. Moreover, the present invention provides a separator for an electricity storage device that contains thermoplastic synthetic fibers A, heat-resistant synthetic fibers B, natural fibers C, and a synthetic resin-based binding agent, and also provides a method of manufacturing the same.

### TECHNICAL FIELD

The present invention relates to a separator for an electricity storage device and, in particular, to a separator for an electricity storage device such as a lithium-ion secondary battery, a polymer-lithium secondary battery, an electric double-layer capacitor, or an aluminum electrolytic capacitor or the like (hereinafter, referred to simply as a ‘separator’).

Priority is claimed on Japanese Patent Application Nos. 2009-064888, filed Mar. 17, 2009 and 2009-065205, filed Mar. 17, 2009, the contents of which are incorporated herein by reference.

### BACKGROUND ART

In recent years, in both industrial equipment and consumer appliances, the increased demand for electrical and electronic equipment as well as the development of hybrid automobiles and the like have led to a remarkable increase in demand for such electronic components as lithium-ion secondary batteries, polymer-lithium secondary batteries, electric double-layer capacitors, and aluminum electrolytic capacitors. In such electrical and electronic equipment, increases in capacity and functionality are progressing at a great pace, and there are demands for the same increases in capacity and functionality to also be brought about in lithium-ion secondary batteries, polymer-lithium secondary batteries, electric double-layer capacitors, and aluminum electrolytic capacitors as the use of such equipment in harsh environments is becoming more and more common.

Lithium-ion secondary batteries and polymer lithium secondary batteries have a structure in which an electrolyte solution for driving is impregnated into an electrode body that is formed by winding or laminating together in the sequence of positive electrode—electrolytic membrane—negative electrode a positive electrode that is formed by mixing an active material, a lithium-containing oxide, and a binder such as polyvinylidene fluoride into 1-methyl-2-pyrolidone and then coating this in sheet form on an aluminum collector, a negative electrode that is formed by mixing a carbonaceous material obtained by occluding and then expelling lithium ions and a binder such as polyvinylidene fluoride into 1-methyl-2-pyrolidone and then coating this in a sheet form on a copper collector, and a porous electrolytic membrane formed from polyethylene or polypropylene or the like, and by then sealing this electrode body in an aluminum case.

An electric double-layer capacitor has the following structure. Firstly, a material obtained by kneading together active carbon, a conductive agent, and a binder is adhered to both surfaces of positive electrode and negative electrode collectors that are both made of aluminum. These are then wound or laminated together via a separator that is formed from cellulose or the like so as to form an electrode body. A drive electrolyte solution is impregnated into this electrode body and the electrode body is packaged using an aluminum case and a sealing body. A positive electrode lead and a negative electrode lead are then passed through the sealing body such that they do not become short-circuited and are drawn outside the package.

An aluminum electrolytic capacitor has the following structure. Firstly, positive electrode foil made from aluminum that has undergone etching and chemical conversion treatment and on which a dielectric membrane has been formed, and negative electrode foil that is made from etched aluminum are wound or laminated together via a separator that is formed from cellulose or the like so as to form an electrode body. A drive electrolyte solution is impregnated into this electrode body and the electrode body is packaged using an aluminum case and a sealing body. A positive electrode lead and a negative electrode lead are then passed through the sealing body such that they do not become short-circuited and are drawn outside the package.

Conventionally, porous membranes such as polyethylene and polypropylene have been used as separators in lithium-ion secondary batteries and polymer-lithium secondary batteries. In addition, paper formed from cellulose pulp or non-woven fabric made from cellulose fiber have been used as separators in electric double-layer capacitors and aluminum electrolytic capacitors.

However, there are increasing demands for further advances in capacity and functionality in electronic components such as those mentioned above. In order to increase capacity, a separator that has mechanical strength, dimensional stability, and sufficient heat-resistance to withstand the self-generated heat that occurs during charging and discharging as well as to withstand abnormal heat generation such as that generated during abnormal charging and the like is sought after. Advances in functionality include improvements in the rapid charging and discharging performance, improvements in high output performance, and an ability to be used in a high-temperature atmosphere and the like, and further reductions in the membrane thickness, improvements in uniformity, and heat-resistance in the separator are being strongly sought after. However, in a conventional separator, not only is the heat-resistance unsatisfactory, but due to the thinness of the membrane there is a tendency for through holes to occur and also for the mechanical strength to deteriorate. As a result, internal short-circuiting occurs between electrodes and there is insufficient uniformity. This generates portions where the migration of ions is concentrated in localized areas, and creates problems such as a reduction in reliability. Moreover, organic solvents and ionic liquids are used for the drive electrolyte solution in the above-described lithium-ion secondary batteries, polymer-lithium secondary batteries, electric double-layer capacitors, and aluminum electrolytic capacitors, and the problem arises that, in separators such as cellulose, these have shown marked deterioration in prolonged durability tests conducted at high temperatures.

In response to requests for this type of separator, a method has been proposed (see, for example, Patent document 1) in which, for example, through holes are formed by means of needles or lasers in a microporous resin film that is manufactured by stretching polyolefin and has a comparatively high air-permeability value, and this microporous resin film is used as the separator. However, if this type of microporous resin film is used by itself, there is a possibility that the positive electrode and negative electrode will become short-circuited because of the through holes. Moreover, such material has a tendency to contract in the meltdown temperature range which is higher than the shutdown temperature so that, as a result, the problem arises that short-circuiting tends to occur between the electrodes at high temperatures.

Moreover, a method has been proposed (see, for example, Patent document 2) in which, by using a separator that contains chemical fibers that have little heat deterioration in a drive electrolyte solution, heat-resistance is increased and the lifespan when used at high temperatures is lengthened. In this description it is stated that the blend proportion of chemical fiber in the separator is approximately 10%, and that a fiber such as cellulose fiber can be used for the remainder. However, in such a separator, in a high-temperature environment where organic solvents and ionic liquids are present, because there is a decrease in the mass of the separator it becomes easy for reductions in strength and durability to occur. Moreover, because high-durability chemical fibers are randomly mixed with low-durability cellulose fibers, the deterioration of the separator in an organic solvent occurs non-uniformly, and there is a tendency for current concentrations to occur. Furthermore, simply because the structure of such a separator is a monolayer structure, there is a tendency for internal short-circuiting to occur if the membrane thickness is reduced.

Moreover, a method has been proposed in other documents (see, for example, Patent document 3) in which, in order to prevent internal short-circuiting, a cylinder paper machine is used to form two or more layers into a single layer. However, in the conventional method, because all of the layers are formed from natural fibers, in a high-temperature environment where organic solvents and ionic liquids are present, decreases in the mass of the separator cause reductions in strength and durability to occur, and the problem arises that it becomes impossible to maintain the product characteristics. In addition, because single-layer sheets which have been formed individually using a cylinder paper machine are laminated together, boundary faces are generated between the layers and these also tend to obstruct the movement of ions.

Moreover, a method has also been proposed (see, for example, Patent document 4) in which fibrillated natural fibers are made into paper sheets via a wet process, and after the paper sheets have been manufactured, they undergo impregnation coating with a paper strengthening agent and are made thinner, so that the resistance of the separator is reduced. However, in separators that are formed solely from natural fibers such as cellulose, in prolonged durability tests conducted at high temperatures the problem arises that deterioration occurs in conjunction with the lowering of the discharge capacity and with the decrease in the film thickness.

Conventional separator manufacturing methods include a conventional carding method in which an olefin-based resin such as polyethylene or polypropylene is used as the raw material, a spunbond method in which a dry non-woven fabric or woven fabric is used as the raw material, and a wet paper manufacturing method in which cellulose and the like is used as the raw material. For example, a wet manufacturing method has been proposed (see, for example, Patent document 5) in which a fluid flow is generated in a fiber web that has been formed from splittable conjugate fibers having a fiber length of 3 to 25 mm. However, if a fluid flow is generated in a fiber web that has been formed from splittable conjugate fibers, the act of splitting the fibers by spraying them with fluid at high pressure causes penetration holes such as pinholes to be generated, and this causes internal short-circuit between electrodes to occur.

A wet paper making method has also been proposed (see, for example, Patent document 6) in which a fibrillated polymer and, fibrillated natural fibers are mixed together or layered to form a sheet. However, there is a tendency in fibrillated fibers for air to become mixed into the fiber surface, and pinholes that have been caused by bubbles that are captured in the nonwoven fabric layer have caused faults such as internal short-circuiting between electrodes.

### DOCUMENTS OF THE PRIOR ART

### Patent documents

Patent document 1: International Patent Application No. WO 01/67536
Patent document 2: Japanese Patent Application Laid-Open (JP-A) No. 2002-367863
Patent document 3: Japanese Patent Publication No. 2892412
Patent document 4: Japanese Patent Application Laid-Open (JP-A) No. 8-273984
Patent document 5: Japanese Patent Application Laid-Open (JP-A) No. 8-273654
Patent document 6: Japanese Patent Application Laid-Open (JP-A) No. 2003-168629

### DISCLOSURE OF INVENTION

### Problems to be Solved by the Invention

The present invention provides a separator for an electricity storage device that is formed as a thin film having heat-resistance, mechanical strength, and dimensional stability, and that has superior ion permeability and low resistance, and in which it is difficult for short-circuiting between electrodes and for self-discharge to occur, and that has superior durability even after prolonged use in a high-temperature environment in the presence of organic solvents and ionic liquids, and also provides a manufacturing method for the same.

### Means for Solving the Problem

In order to solve the above described problems, a first aspect of the present invention provides the following structures.

(1) A separator for an electricity storage device that is formed by superimposing two or more fiber layers, wherein at least one or more of the fiber layers is a synthetic fiber layer that contains synthetic fibers and a synthetic resin-based binding agent.
(2) The separator for an electricity storage device according to (1), wherein the synthetic resin-based binding agent includes at least one type selected from a group made up of carboxymethyl cellulose and styrene—butadiene rubber.
(3) The separator for an electricity storage device according to any of (1) to (2), wherein the synthetic resin-based binding agent is melted by heat treatment.
(4) The separator for an electricity storage device according to any of (1) to (3), wherein the synthetic fibers include at least one type selected from a group made up of polyethylene terephthalate, polybutylene terephthalate, aromatic polyamide, aromatic polyester, semi-aromatic polyamide, polyphenylene sulfide, polyparaphenylene benzobisoxazole, polyethylene, polypropylene, aramid, and polyalylate.
(5) The separator for an electricity storage device according to any of (1) to (4), wherein the fiber diameter of the synthetic fibers is 5 μm or less, and the fiber length of the synthetic fibers is 10 mm or less.
(6) The separator for an electricity storage device according to any of (1) to (5), wherein the two or more fiber layers are layered one on top of the other on a paper making net using a tilted wire paper making machine having two or more heads.
(7) The separator for an electricity storage device according to any of (1) to (6), wherein the two or more fiber layers are formed by using a multi-tank tilting wet paper machine that has a structure in which the bottom portion of a second flow box is positioned in the vicinity of an intersecting portion between a paper making net and a waterline inside a first flow box, and that is able to simultaneously form a plurality of layers, and by layering the two or more fiber layers together one on top of the other on the paper making net.
(8) The separator for an electricity storage device according to any of (1) to (7), wherein the electricity storage device is any one of a lithium-ion secondary battery, a polymer-lithium secondary battery, an electric double-layer capacitor, and an aluminum electrolytic capacitor.
(9) A method of manufacturing a separator for an electricity storage device that includes a step in which the separator for an electricity storage device according to any of (1) to (8) is obtained by performing spray-coating so as to coat a synthetic resin-based binding agent onto fiber layers in a dry state or fiber layers in a wet state.

A second aspect of the present invention provides the following.

(10) A separator for an electricity storage device that contains thermoplastic synthetic fibers A, heat-resistant synthetic fibers B, natural fibers C, and a synthetic resin-based binding agent.
(11) The separator for an electricity storage device according to (10), wherein the synthetic resin-based binding agent includes at least one type selected from a group made up of carboxymethyl cellulose and styrene-butadiene rubber.
(12) The separator for an electricity storage device according to any of (10) to (11), wherein the synthetic resin-based binding agent is melted by heat treatment.
(13) The separator for an electricity storage device according to any of (10) to (12), wherein the thermoplastic synthetic fibers A include at least one type selected from a group made up of polyethylene terephthalate, polybutylene terephthalate, aromatic polyalylate, polyethylene, and polypropylene.
(14) The separator for an electricity storage device according to any of (10) to (13), wherein the heat-resistant synthetic fibers B include at least one type selected from a group made up of aromatic polyamide, aromatic polyester, semi-aromatic polyamide, polyphenylene sulfide, and polyparaphenylene benzobisoxazole.
(15) The separator for an electricity storage device according to any of (10) to (14), wherein the thermoplastic synthetic fibers A, the heat-resistant synthetic fibers B, and the natural fibers C are in respective blend proportions of 25 to 50 percent by mass, 60 to 10 percent by mass, and 15 to 40 percent by mass.
(16) The separator for an electricity storage device according to any of (10) to (15), wherein the fiber diameter of the thermoplastic synthetic fibers A is 5 μm or less, and the fiber length of the thermoplastic synthetic fibers A is 10 mm or less.
(17) The separator for an electricity storage device according to any of (10) to (16), wherein the fiber diameter of the heat-resistant synthetic fibers B is 1 μm or less, and the fiber length of the heat-resistant synthetic fibers B is fibrillated to 10 mm or less.
(18) The separator for an electricity storage device according to any of (10) to (17), wherein the natural fibers C are solvent-spun cellulose that has been fibrillated to a fiber diameter of 1 μm or less, and a fiber length of 3 mm or less.
(19) The separator for an electricity storage device according to any of (10) to (18), wherein the heat-resistant synthetic fibers B and the natural fibers C are fibrillated, and are formed by being interleaved with at least one type of fiber selected from a group made up of the thermoplastic synthetic fibers A, the fibrillated heat-resistant fibers B, and the fibrillated natural fibers C.
(20) The separator for an electricity storage device according to any of (10) to (19), wherein the film thickness of the separator for an electricity storage device is 60 μm or less.
(21) The separator for an electricity storage device according to any of (10) to (20), wherein the density of the separator for an electricity storage device is between 0.2 and 0.7 g/cm³.
(22) The separator for an electricity storage device according to any of (10) to (21), wherein the air permeability of the separator for an electricity storage device is 100 sec/100 ml or less.
(23) The separator for an electricity storage device according to any of (10) to (22), wherein the electricity storage device is any one of a lithium-ion secondary battery, a polymer-lithium secondary battery, an electric double-layer capacitor, and an aluminum electrolytic capacitor.
(24) A method of manufacturing a separator for an electricity storage device that includes a step in which the separator for an electricity storage device according to any one of any of (10) to (23) is obtained by performing spray-coating so as to coat a synthetic resin-based binding agent onto fiber layers in a dry state or fiber layers in a wet state.

### Effects of the Invention

The present invention provides a separator in which, after a synthetic resin-based binding agent has been coated onto a separator that has been dried after undergoing a paper-forming process, or alternatively, after a synthetic resin-based binding agent has been coated onto a separator which is in a wet-paper state, heat treatment is performed on the binding agent so that it becomes fused and strengthens the bonds between the fibers. As a result of this, the puncture strength is improved. Furthermore, because the fibers become fixed together by the fused synthetic resin-based binding agent, the crushing strength in the film-thickness direction (i.e., the Z-axial direction) is improved and the separator is provided with excellent anti-short-circuiting properties.

Furthermore, by covering the fibers with the synthetic resin-based binding agent, it is possible to provide a separator that has improved resistance to organic solvents and ionic liquids and also has improved durability under high-temperature conditions, and that has excellent durability when used for prolonged long periods at high temperatures so that it does not easily deteriorate even if it is used continuously for long periods in a high-temperature atmosphere.

The separator of the present invention is formed as a thin film having heat-resistance, mechanical strength, and dimensional stability, and also having superior ion permeability and low resistance. This separator is also excellent at suppressing short-circuiting between electrodes and preventing self-discharge from occurring. It also has superior durability even after prolonged use at high temperatures in the presence of organic solvents and ionic liquids. Accordingly, the separator of the present invention can be favorably used as an electricity storage device, and particularly, for lithium-ion secondary batteries, polymer-lithium secondary batteries, electric double-layer capacitors, or aluminum electrolytic capacitors.

### BRIEF DESCRIPTION OF THE DRAWINGS

FIG. 1 is a cross-sectional view showing the structure of a multi-tank tilting wet paper machine according to the present invention.

### BEST MODE FOR CARRYING OUT THE INVENTION

The separator for an electricity storage device of a first aspect of the present invention is a separator that is formed by superimposing two or more fiber layers, and in which at least one of the fiber layers is a synthetic fiber layer that contains synthetic fibers and a synthetic resin-based binding agent.

For the synthetic resin-based binding agent it is possible to use at least one type selected from ethylene-propylene-diene terpolymers, acrylonitrile-butadiene rubber, fluoro rubber, polyvinyl acetate, polymethyl methacrylate, cellulose nitrate, polyvinylidene fluoride, polyethylene, polypropylene, polytetrafluoroethylene, tetrafluoroethylene-hexafluoropropylene copolymers, polyvinylidene fluoride-chlorotrifluoroethylene copolymers, styrene-butadiene rubber (SBR), and carboxymethyl cellulose (CMC). However, styrene-butadiene rubber (SBR), which is commercially available in the form of an aqueous emulsion, and aqueous carboxymethyl cellulose (CMC) are particularly preferable as they leave no residual organic solvent in the separator.

The synthetic resin-based binding agent is preferably coated at a quantity of between 5 parts by mass and 200 parts by mass relative to 100 parts by mass of fiber, and particularly preferably at a rate of between 10 parts by mass and 150 parts by mass. If the quantity is less than 5 parts by mass, then it is difficult for the effects of the present invention to become evident, while if the quantity is more than 200 parts by mass, the holes becomes filled with the synthetic resin-based binding agent so that the separator turns into a film.

The solvent used when the binding agent is being blended or coated can be either a non-aqueous solvent or an aqueous solution. For the non-aqueous solvent it is possible to use N-methyl-2-pyrrolidone (NMP), dimethylformamide, dimethylacetamide, methyl ethyl ketone, cyclohexanone, methyl acetate, methyl acrylate, diethyltriamine, N—N-dimethylaminopropylamine, ethylene oxide, and tetrahydrofuran and the like. In contrast, a dispersing agent, a thickening agent and the like can be added to the aqueous solution that is used.

The synthetic fibers that are used in the present invention are preferably formed from a resin selected from polyethylene terephthalate, polybutylene terephthalate, aromatic polyamide, aromatic polyester, semi-aromatic polyamide, polyphenylene sulfide, polyparaphenylene benzobisoxazole, polyethylene, polypropylene, aramid, and polyalylate, however, the synthetic fibers are not necessarily limited to these and any synthetic fibers may be used provided that they have high heat-resistance and do not dissolve in the organic solvent or ionic liquid that is used in the driving electrolyte solution. By superimposing synthetic fiber layers that contain these synthetic fibers, the durability of the separator against organic solvents and ionic liquids is increased, and any deterioration when the separator is used continuously in a high-temperature atmosphere for a long period is suppressed.

In the present invention, other fibers that may be used in the synthetic fiber layer that contains the aforementioned synthetic fibers, and in the fiber layers that are layered together with this synthetic fiber layer may be selected from among the aforementioned synthetic fibers. Alternatively, synthetic fibers other than those mentioned above, or else cellulose fibers and the like formed from natural pulp may also be used. These synthetic fibers and cellulose fibers and the like are preferably able to be defiberized in order to improve the retention capability of the electrolyte solution, or to form a uniform fiber layer.

In the present invention, the fiber diameter of the synthetic fibers is preferably not more than 5 μm and the fiber length thereof is preferably not more than 10 mm, and particularly preferably, these are not more than 3 μm and 3 mm respectively. If the fiber diameter exceeds 5 μm or if the fiber length exceeds 10 mm, then there is an increased possibility that puncture holes will be formed after the film-thinning process, and that such holes will cause internal short-circuiting.

In the present invention, the pore diameter of the synthetic fiber layer is preferably such that the mean hole diameter obtained via the bubble point method is in a range of between 0.1 μm and 15 μm, and more preferably is in a range of between 0.1 μm and 5.0 μm. If the mean pore diameter is smaller than 0.1 μm, there is a deterioration in ionic conductivity and a likely increase in internal resistance. In addition, because it becomes difficult to expel water during the manufacturing of the separator, manufacturing the separator becomes more problematic. If the mean pore diameter exceeds 15 μm, there is a tendency for internal short-circuiting to occur after the film-thinning process. Note that a porometer manufactured by Seika Corporation Ltd. may be used for the measurement of the pore diameter using the bubble point method.

The thickness of the separator of the present invention is preferably not more than 50 μm. If the thickness of the separator exceeds 50 μm, then not only is it difficult to reduce the thickness of the electrochemical element, but at the same time the quantity of electrode material that can be inserted into a fixed cell volume is reduced. This not only causes a reduction in capacity, but also increases resistance and is therefore not preferable.

The density of the separator of the present invention is preferably between 0.20 g/cm³ and 0.75 g/cm³. If the density is less than 0.20 g/cm³, there are too many void portions in the separator and it is easy for short-circuiting to occur, or for faults such as deterioration in the self-discharge resistance to occur. In contrast, if the density is greater than 0.75 g/cm³, then there may be too many different blockages of the material forming the separator so that the movement of ions is obstructed which makes it easy for resistance to increase.

It is preferable for the void ratio in the separator of the present invention to be within a range of between 30% and 90% as this enables both a prevention of short-circuiting and a suppression of increases in resistance to be achieved. The void ratio referred to here is determined by the following formula using the basis weight M (g/cm²), the thickness T (μm), and the density D (g/cm³).

void ratio (%)=[1−(M/T)/D]×100

As has been described above, the separator of the present invention has a layered structure in which two or more fiber layers are superimposed, and in which at least one of the layers is formed by a synthetic fiber layer that contains one of the aforementioned synthetic fibers having heat-resistance, and contains a synthetic resin-based binding agent. As a consequence, this separator shows minimal deterioration in organic solvents and ionic liquids in high-temperature atmospheres and can be favorably used in electricity storage devices such as lithium-ion secondary batteries, polymer-lithium secondary batteries, electric double-layer capacitors, or aluminum electrolytic capacitors. Note that when an electricity storage device is manufactured using the separator of the present invention, the materials used to form electrochemical elements such as positive electrodes, negative electrodes, electrolyte solutions and the like may be any suitable conventionally known material.

Next, a method of manufacturing the separator of the present invention will be described, however, the present invention is not limited to this and it is also possible to manufacture the separator of the present invention by employing other methods.

Firstly, one or more types of synthetic fiber that have been cut or defiberized so as to have a fiber diameter of 5 μm or less and a fiber length of 10 mm or less are dispersed in water. Because the fibers used in the present invention are extremely minute, it is difficult to disperse them uniformly in the defibering step. Accordingly, by employing a dispersing apparatus such as a pulper or agitator, or an ultrasonic dispersing apparatus, it is possible to obtain good dispersion. The water that is used in this dispersion step is preferably ion-exchanged water as this enables ionic impurities to be reduced to a minimum. Next, the same type of synthetic fibers as those mentioned above, or else fibers of a different kind are dispersed in water using a different dispersing apparatus such as a pulper or agitator from the aforementioned dispersing apparatus. The defiberization can be accomplished using a typical defibrator such as a ball mill, a beater, a Lampell Mill, a PFI mill, an SDR (single disk refiner), a DDR (double disk refiner), a high-pressure homogenizer, a homomixer, or some other type of refiner.

The fiber dispersion obtained in the above described manner is used to manufacture paper using a wet paper machine such as a Fourdrinier paper machine, a short web paper machine, a cylinder paper machine, and a tilted paper machine. Water is expelled using a continuous wire mesh type of dehydrating part. Among these wet paper making machines, if a tilted wire paper making machine which has two heads is used, then when two or more fiber layers are layered together one on top of the other, it is difficult for boundaries to be generated between the fiber layers, and a uniform separator without pinholes can be obtained. After the mixing, a dried separator can be obtained by passing it through a drying part such as a multi-cylinder-type or Yankee-type of dryer or the like. The dried separator that has undergone this paper making process then undergoes impregnation coating with a synthetic resin-based binding agent solution that has been diluted to the desired strength. The coating method used to perform impregnation coating on the separator may employ a direct roll coater, a dip coater, a spray coater, or a kiss-roll coater or the like. Once the separator has been dried by being passed through a drying part such as a multi-cylinder-type or Yankee-type of dryer or the like, the manufacturing of the separator is completed.

Note that it is more preferable for the impregnation coating of the synthetic resin-based binding agent solution to be performed when the separator is in a wet state by spray-coating the separator over a wire part, or over felt or canvas, or over a carrier that allows both water and air to flow freely. When impregnation coating is performed when the separator is in a dry state, there is a tendency for fractures and wrinkling to occur in the separator. Accordingly, the preferred coating method is spray-coating.

In particular, as the paper manufacturing method, a method in which a multi-tank tilting wet paper machine that has a structure in which the bottom portion of a second flow box is positioned in the vicinity of an intersecting portion between a paper making net and a waterline inside a first flow box, and that is able to simultaneously form a plurality of layers is used, and in which the fiber layers are layered together one on top of the other on the paper making net is even more preferable as the fibers in the respective fiber layers become mutually interleaved with each other between the superimposed layers so that it is difficult for them to become separated from each other. Moreover, a separator that is obtained using a multi-tank tilting wet paper machine does not allow boundaries to be formed easily between fiber layers so that a uniform separator without pinholes can be obtained.

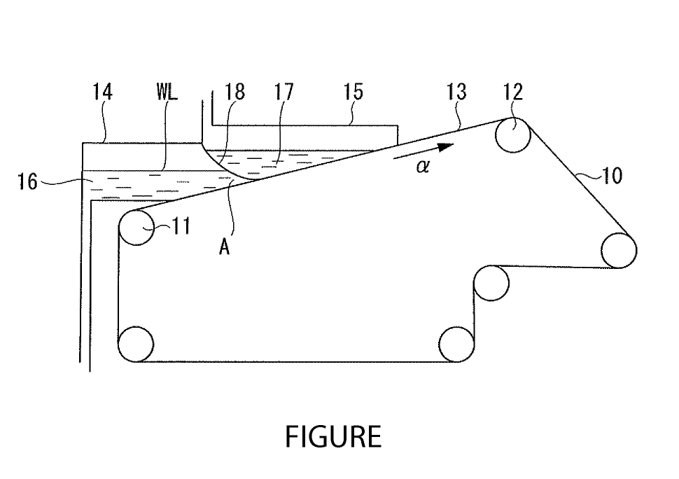

This type of multi-tank tilting wet paper machine has a structure such as that shown in FIG. 1. As is shown in FIG. 1, a paper making net 10 is made to travel in the direction of an arrow a by a plurality of guide rollers. The portion of the paper making net 10 that is tilted between a guide roller 11 and a guide roller 13 is called a tilted travel portion 13. In the present invention, a bottom portion of a second flow box 15 is positioned in the vicinity A of an intersecting portion between a waterline WL and the tilted travel portion 13 inside a first flow box 14. In this vicinity A of the intersecting portion, a dispersion 16 that contains fibers inside the first flow box 14 and a dispersion 17 that contains fibers inside the second flow box 15 are adjacent to each other via a partition wall 18. A gap is provided between the partition wall 18 and the tilted travel portion 13 in the vicinity A of the intersecting portion, and the dispersion 16 that flows out from the first flow box 14 in conjunction with the traveling of the paper making net 10 passes through this gap and becomes blended into the dispersion 17 inside the second flow box 17.

The separator for an electricity storage device of a second aspect of the present invention is a separator for an electricity storage device that contains thermoplastic synthetic fibers A (referred to below as the fibers A), heat-resistant synthetic fibers B (referred to below as the fibers B), and natural fibers C (referred to below as the fibers C), as well as a synthetic resin-based binding agent.

For the synthetic resin-based binding agent it is possible to use at least one type selected from ethylene-propylene-diene terpolymers, acrylonitrile-butadiene rubber, fluoro rubber, polyvinyl acetate, polymethyl methacrylate, cellulose nitrate, polyvinylidene fluoride, polyethylene, polypropylene, polytetrafluoroethylene, tetrafluoroethylene-hexafluoropropylene copolymers, polyvinylidene fluoride-chlorotrifluoroethylene copolymers, styrene-butadiene rubber (SBR), and carboxymethyl cellulose (CMC). However, styrene-butadiene rubber (SBR), which is commercially available in the form of an aqueous emulsion, and aqueous carboxymethyl cellulose (CMC) are particularly preferable as they leave no residual organic solvent in the separator.

The synthetic resin-based binding agent is preferably contained in a quantity of between 5 parts by mass and 200 parts by mass relative to 100 parts by mass of the total fibers A, B, and C, and particularly preferably at a rate of between 10 parts by mass and 150 parts by mass. If the quantity is less than 5 parts by mass, then it is difficult for the effects of the present invention to become evident, while if the quantity is more than 200 parts by mass, the holes becomes filled with the synthetic resin-based binding agent so that the separator turns into a film.

The solvent used when the binding agent is being blended or coated can be either a non-aqueous solvent or an aqueous solution. For the non-aqueous solvent it is possible to use N-methyl-2-pyrrolidone (NMP), dimethylformamide, dimethylacetamide, methyl ethyl ketone, cyclohexanone, methyl acetate, methyl acrylate, diethyltriamine, N—N-dimethylaminopropylamine, ethylene oxide, and tetrahydrofuran and the like. In contrast, a dispersing agent, a thickening agent and the like can be added to the aqueous solution that is used.

As the fibers A that are used in the present invention, fibers that are formed from a resin selected from polyethylene terephthalate, polybutylene terephthalate, polyester fibers such as aromatic polyalylate and the like, polyethylene, and polypropylene are preferably used.

As the fibers B, either one type or two or more types selected from aromatic polyamides, aromatic polyesters, semi-aromatic polyamides, polyphenylene sulfide, and polyparaphenylene benzobisoxazole may be used. The fibers B are not dissolved in the organic solvent or ionic liquid that is used in the driving electrolyte solution, and can be fibrillated into microfibers.

By including the fibers B in the separator, the durability of the separator against organic solvents and ionic liquids and also against high-temperature conditions is increased, and any deterioration when the separator is used continuously in a high-temperature atmosphere for a prolonged period is suppressed. Moreover, by using fibrillated fibers B, it is difficult for pinholes to be generated and the resulting separator is excellent in preventing short-circuiting.

As the fibers C used in the present invention, it is possible to use, for example, cotton, hemp, kenaf, banana, pineapple, wool, silk, angora, cashmere, rayon, cupra, polynosic, and solvent-spun cellulose and the like. One or two or more types of material may be used to form the fibers C. The impregnation of the electrolyte solution in a separator that uses these materials is improved. In the present invention, it is preferable for fibers that have been fibrillated into microfibers to be used for the fibers C, and it is particularly preferable for fibrillated solvent-spun cellulose to be used. Fibrillated solvent-spun cellulose has superior impregnation of the electrolyte solution, and satisfactory interleaving of the fibers so that the resulting separator also has excellent mechanical strength.

In the present invention, the fiber diameter of the fibers A is preferably not more than 5 μm and the fiber length thereof is preferably not more than 10 mm, and particularly preferably, these are not more than 3 μm and 7 mm respectively. If the fiber diameter exceeds 5 μm or if the fiber length exceeds 10 mm, then there is an increased possibility that puncture holes will be formed after the film-thinning process, and that such holes will cause internal short-circuiting.

In the present invention, the fiber diameter of the fibrillated fibers B is preferably not more than 1 μm and the fiber length thereof is preferably not more than 10 mm, and particularly preferably, the fiber length is not more than 1 mm. If the fiber diameter exceeds 1 μm or if the fiber length exceeds 10 mm, then there is an increased possibility that puncture holes will be formed after the film-thinning process, and that such holes will cause internal short-circuiting. The interleaving between fibers is also weakened and there is a tendency for the mechanical strength to be weakened.

In the present invention, the fiber diameter of the fibrillated fibers C is preferably not more than 1 μm and the fiber length thereof is preferably not more than 3 mm, and particularly preferably, the fiber length is not more than 1 mm. If the fiber diameter exceeds 1 μm or if the fiber length exceeds 3 mm, then there is an increased possibility that puncture holes will be formed after the film-thinning process, and that such holes will cause internal short-circuiting. The interleaving between fibers is also weakened and there is a tendency for the mechanical strength to be weakened. In addition, sufficient impregnation of the electrolyte solution cannot be obtained.

In the present invention, it is preferable for the fibers A, the fibers B, and the fibers C to have the following blend ratios in relation to the total quantity of fibers.

Namely, it is preferable for the fibers A to be blended in a range of between 25 and 50% by mass of the total quantity of fibers that make up the separator. If the quantity is less than 25% by mass, then it is not possible for a satisfactory anti-squashing effect (i.e., a spacer effect) in the Z-axial direction of the separator to be exhibited, and compression makes it possible for short-circuiting to easily occur. If the quantity exceeds 50% by mass, there is a deterioration in the void ratio and holes become closed off, and this leads to an increase in the internal resistance. Furthermore, due to the thermoplasticity of these fibers, they become unstable at high temperatures, and this also leads to a deterioration in durability. Furthermore, the quantity of fibrillated microfibers in the separator is also reduced to less than 50% by mass, so that it becomes impossible to control the hole diameter of the separator, and the effect of this is that internal short-circuiting is generated.

Moreover, it is preferable for the fibers B to be blended in a range of between 60 and 10% by mass of the total quantity of fibers that make up the separator. If the quantity is less than 10% by mass, then the quantity of fibrillated microfibers is insufficient, so that it becomes impossible to control the hole diameter of the separator, and the effect of this is that internal short-circuiting is generated. If the quantity exceeds 60% by mass, the quantity of fibrillated microfibers is too great, and the separator becomes too dense. The effect of this is that there is an increase in internal resistance.

Furthermore, it is preferable for the fibers C to be blended in a range of between 15 and 40% by mass of the total quantity of fibers that make up the separator. If the quantity is less than 15% by mass, the interleaving between fibers is weakened and there is a tendency for the mechanical strength to be weakened. In addition, sufficient impregnation of the electrolyte solution cannot be obtained. If the quantity exceeds 40% by mass, this tends to reduce the durability against organic solvents and ionic liquids in high-temperature atmospheric conditions.

In the present invention, the pore diameter of the fiber layer after the synthetic resin-based binding agent has been admixed is preferably such that the mean hole diameter obtained via the bubble point method is in a range of between 0.1 μm and 15 μm, and more preferably between 0.1 μm and 5.0 μm. If the mean pore diameter is smaller than 0.1 μm, there is a deterioration in ionic conductivity and a likely increase in internal resistance. In addition, because it becomes difficult to expel water during the manufacturing of the separator, manufacturing the separator becomes more problematic. If the mean pore diameter exceeds 15 μm, there is a tendency for internal short-circuiting to occur after the film-thinning process. Note that a porometer manufactured by Seika Corporation Ltd. may be used for the measurement of the pore diameter using the bubble point method.

The thickness of the separator of the present invention is preferably not more than 60 μm. If the thickness of the separator exceeds 60 μm, then not only is this a drawback in reducing the thickness of the electricity storage device, but at the same time the quantity of electrode material that can be inserted into a fixed cell volume is reduced. This not only causes a reduction in capacity, but also increases resistance and is therefore not preferable.

The density of the separator of the present invention is preferably between 0.2 g/cm³ and 0.7 g/cm³, and more preferably between 0.25 g/cm³ and 0.65 g/cm³, and particularly preferably between 0.3 g/cm³ and 0.6 g/cm³. If the density is less than 0.2 g/cm³, there are too many void portions in the separator and it is easy for short-circuiting to occur, or for faults such as deterioration in the self-discharge resistance to occur. In contrast, if the density is greater than 0.7 g/cm³, then there may be too many different blockages of the material forming the separator so that the movement of ions is obstructed which makes it easy for resistance to increase.

The air permeability of the separator of the present invention is preferably 100 sec/100 ml or less. This enables the ion conductivity to be maintained at a favorable level. Note that the air permeability in the separator of the present invention is a value which is measured using a Gurley air permeability tester.

As has been described above, because the separator of the present invention is formed by the fibers A, the fibers B, and the fibers C, and contains a synthetic resin-based binding agent, and because this binding agent is fused by heat treatment, in addition to having superior puncture strength, crushing strength in the film-thickness direction (i.e., the Z-axial direction), and resistance to short-circuiting, it does not easily deteriorate in organic solvents and ionic liquids even in high-temperature environments, and can be favorably used in electricity storage devices such as lithium-ion secondary batteries, polymer-lithium secondary batteries, electric double-layer capacitors, and aluminum electrolytic capacitors. Note that when an electricity storage device is manufactured using the separator of the present invention, the materials used to form electrochemical elements such as positive electrodes, negative electrodes, electrolyte solutions and the like may be any suitable conventionally known material.

Next, a method of manufacturing the separator of the present invention will be described, however, the present invention is not limited to this and it is also possible to manufacture the separator of the present invention by employing other methods.

Firstly, one or more types of the fibers A that have been cut or defiberized so as to have a fiber diameter of 5 μm or less and a fiber length of 10 mm or less, the fibers B that have been fibrillated to a fiber diameter of 1 μm or less and a fiber length of 3 mm or less, and the fibers C that have been fibrillated to a fiber diameter of 1 μm or less and a fiber length of 3 mm or less are dispersed in water. The order in which the fibers are immersed in the water is not particularly limited. Because the fibers used in the present invention are extremely minute, it is difficult to disperse them uniformly in the defibering step. Accordingly, by employing a dispersing apparatus such as a pulper or agitator, or an ultrasonic dispersing apparatus, it is possible to obtain good dispersion. The water that is used in this dispersion step is preferably ion-exchanged water or pure water as this enables ionic impurities to be reduced to a minimum. Next, the same type of synthetic fibers as those mentioned above or else fibers of a different kind are dispersed in water using a different dispersing apparatus such as a pulper or agitator from the aforementioned dispersing apparatus. The defiberization can be accomplished using a typical defibrator such as a ball mill, a beater, a Lampell Mill, a PFI mill, an SDR (single disk refiner), a DDR (double disk refiner), a high-pressure homogenizer, a homomixer, or some other type of refiner.

The fiber dispersion obtained in the above described manner is used to manufacture paper using a wet paper machine such as a Fourdrinier paper machine, a short web paper machine, a cylinder paper machine, and a tilted paper machine. Water is expelled using a continuous wire mesh type of dehydrating part. Among these wet paper making machines, if a tilted wire paper making machine which has two heads is used, then when two or more fiber layers are layered together one on top of the other, it is difficult for boundaries to be generated between the fiber layers, and a uniform separator without pinholes can be obtained. After the mixing, a dried separator can be obtained by passing it through a drying part such as a multi-cylinder-type or Yankee-type of dryer or the like. The dried separator that has undergone this paper making process then undergoes impregnation coating with a synthetic resin-based binding agent solution that has been diluted to the desired strength. The coating method used to perform impregnation coating on the separator may employ a direct roll coater, a dip coater, a spray coater, or a kiss-roll coater or the like. Once the separator has been dried by being passed through a drying part such as a multi-cylinder-type or Yankee-type of dryer or the like, the manufacturing of the separator is completed.

Note that it is more preferable for the impregnation coating of the synthetic resin-based binding agent solution to be performed when the manufactured fiber layer is in a wet state by spray-coating the fiber dispersion over a wire part, or over felt or canvas, or over a carrier that allows both water and air to flow freely. When impregnation coating is performed when the separator is in a dry state, there is a tendency for fractures and wrinkling to occur in the separator. Accordingly, the preferred coating method is spray-coating.

### EXAMPLES

### Example 1

Polyethylene terephthalate fibers having a fiber diameter of 2.5 μm and a fiber length of 6 mm were placed in a pulper in ion-exchange water at a density of 0.05% by mass, and were dispersed for 30 minutes so as to prepare a fiber dispersion A. Next, aromatic polyamide fibrillated to a fiber diameter of 0.2 μm and a fiber length of 0.6 mm and solvent-spun cellulose fibrillated to a fiber diameter of 0.5 μm and a fiber length of 1 mm were blended together in a proportion of 1:1 by mass ratio. These fibers were placed in a different pulper from the aforementioned pulper in ion-exchange water at a density of 0.05% by mass, and were then dispersed for 30 minutes so as to prepare a fiber dispersion B.

The fiber dispersion A was made into sheet paper using a standard handsheet machine specified in JIS P8222 so that a wet paper sheet was obtained. The dispersion B was then layered on top of this sheet. Thereafter, the obtained wet paper sheet was removed from the handsheet machine, and a carboxymethyl cellulose aqueous solution was spray-coated thereon such that the coating amount when dry was 20 parts by mass relative to 100 parts by mass of the total dried fibers. Subsequently, the paper sheet was dried in a Yankee drier at 130° C. so that the separator of the present invention was obtained.

The properties of the obtained separator were as follows: a density of 0.40 g/cm³, a void ratio of 73%, and a separator thickness of 30 μm.

### Example 2

Other than altering the carboxymethyl cellulose aqueous solution of Example 1 to an SBR aqueous emulsion, a separator of the present invention was prepared in the same way.

The properties of the obtained separator were as follows: a density of 0.43 g/cm³, a void ratio of 75%, and a separator thickness of 32 μm.

### Example 3

Other than altering the spray-coat quantity after drying of the carboxymethyl cellulose aqueous solution of Example 1 to 10 parts by mass, a separator of the present invention was prepared in the same way.

The properties of the obtained separator were as follows: a density of 0.40 g/cm³, a void ratio of 73%, and a separator thickness of 30 μm.

### Example 4

Other than altering the spray-coat quantity after drying of the carboxymethyl cellulose aqueous solution of Example 1 to 60 parts by mass, a separator of the present invention was prepared in the same way.

The properties of the obtained separator were as follows: a density of 0.52 g/cm³, a void ratio of 70%, and a separator thickness of 33 μm.

### Example 5

Other than altering the spray-coat quantity after drying of the carboxymethyl cellulose aqueous solution of Example 1 to 150 parts by mass, a separator of the present invention was prepared in the same way.

The properties of the obtained separator were as follows: a density of 0.55 g/cm³, a void ratio of 69%, and a separator thickness of 35 μm.

### Example 6

Polyethylene terephthalate fibers having a fiber diameter of 2.5 μm and a fiber length of 6 mm were placed in a pulper in ion-exchange water at a density of 0.05% by mass, and were dispersed for 30 minutes so as to prepare a fiber dispersion A. Next, aromatic polyamide fibrillated to a fiber diameter of 0.2 μm and a fiber length of 0.6 mm and solvent-spun cellulose fibrillated to a fiber diameter of 0.5 μm and a fiber length of 1 mm were blended together in a proportion of 1:1 by mass ratio. These fibers were placed in a different pulper from the aforementioned pulper in ion-exchange water at a density of 0.05% by mass, and were then dispersed for 30 minutes so as to prepare a fiber dispersion B.

The fiber dispersion A was made into sheet paper using a standard handsheet machine specified in JIS P8222 so that a wet paper sheet was obtained. The dispersion B was then layered on top of this sheet. Thereafter, the obtained wet paper sheet was removed from the handsheet machine, and was dried in a Yankee drier at 130° C. Subsequently, a carboxymethyl cellulose aqueous solution was spray-coated thereon such that the coating amount when dry was 20 parts by mass relative to 100 parts by mass of the total dried fibers. The paper sheet was then dried in a Yankee drier at 130° C. so that the separator of the present invention was obtained.

The properties of the obtained separator were as follows: a density of 0.40 g/cm³, a void ratio of 73%, and a separator thickness of 30 μm.

### Example 7

Polyethylene terephthalate fibers having a fiber diameter of 2.5 μm and a fiber length of 6 mm and aromatic polyamide fibrillated to a fiber diameter of 0.2 μm and a fiber length of 0.6 mm were blended together in a proportion of 1:1 by mass ratio, and were placed in a pulper in ion-exchange water at a density of 0.05% by mass, and were dispersed for 30 minutes so as to prepare a fiber dispersion E. Next, solvent-spun cellulose fibrillated to a fiber diameter of 0.5 μm and a fiber length of 1 mm was placed in a different pulper from the aforementioned pulper in ion-exchange water at a density of 0.05% by mass, and was dispersed for 30 minutes so as to prepare a fiber dispersion F.

The fiber dispersion E was made into sheet paper using a standard handsheet machine specified in JIS P8222 so that a wet paper sheet was obtained. The dispersion F was then layered on top of this sheet. Thereafter, the obtained wet paper sheet was removed from the handsheet machine, and a carboxymethyl cellulose aqueous solution was spray-coated thereon such that the coating amount when dry was 20 parts by mass relative to 100 parts by mass of the total dried fibers. Subsequently, the paper sheet was dried in a Yankee drier at 130° C. so that the separator of the present invention was obtained.

The properties of the obtained separator were as follows: a density of 0.39 g/cm³, a void ratio of 74%, and a separator thickness of 30 μm.

### Example 8

Polyethylene terephthalate fibers having a fiber diameter of 2.5 μm and a fiber length of 6 mm and polyphenylene sulfide fibrillated to a fiber diameter of 0.8 μm and a fiber length of 1.5 mm were blended together in a proportion of 1:1 by mass ratio, and were placed in a pulper in ion-exchange water at a density of 0.05% by mass, and were dispersed for 30 minutes so as to prepare a fiber dispersion G. Next, solvent-spun cellulose fibrillated to a fiber diameter of 0.5 μm and a fiber length of 1 mm was placed in a different pulper from the aforementioned pulper in ion-exchange water at a density of 0.05% by mass, and was dispersed for 30 minutes so as to prepare a fiber dispersion H.

The fiber dispersion G was made into sheet paper using a standard handsheet machine specified in JIS P8222 so that a wet paper sheet was obtained. The dispersion H was then layered on top of this sheet. Thereafter, the obtained wet paper sheet was removed from the handsheet machine, and a carboxymethyl cellulose aqueous solution was spray-coated thereon such that the coating amount when dry was 20 parts by mass relative to 100 parts by mass of the total dried fibers. Subsequently, the paper sheet was dried in a Yankee drier at 130° C. so that the separator of the present invention was obtained.

The properties of the obtained separator were as follows: a density of 0.44 g/cm³ a void ratio of 74%, and a separator thickness of 31 μm.

### Example 9

Aromatic polyester fibers fibrillated to a fiber diameter of 0.2 μm and a fiber length of 0.6 mm were placed in a pulper in ion-exchange water at a density of 0.05% by mass, and were dispersed for 30 minutes so as to prepare a fiber dispersion I. Next, solvent-spun cellulose fibrillated to a fiber diameter of 0.5 μm and a fiber length of 1 mm was placed in a different pulper from the aforementioned pulper in ion-exchange water at a density of 0.05% by mass, and was dispersed for 30 minutes so as to prepare a fiber dispersion J.

The fiber dispersion I was made into sheet paper using a standard handsheet machine specified in JIS P8222 so that a wet paper sheet was obtained. The dispersion J was then layered on top of this sheet. Thereafter, the obtained wet paper sheet was removed from the handsheet machine, and a carboxymethyl cellulose aqueous solution was spray-coated thereon such that the coating amount when dry was 20 parts by mass relative to 100 parts by mass of the total dried fibers. Subsequently, the paper sheet was dried in a Yankee drier at 130° C. so that the separator of the present invention was obtained.

The properties of the obtained separator were as follows: a density of 0.42 g/cm³, a void ratio of 73%, and a separator thickness of 29 μm.

### Example 10

Aromatic polyester fibers fibrillated to a fiber diameter of 0.2 μm and a fiber length of 0.6 mm were placed in a pulper in ion-exchange water at a density of 0.05% by mass, and were dispersed for 30 minutes so as to prepare a fiber dispersion K. Next, aromatic polyamide fibrillated to a fiber diameter of 0.2 μm and a fiber length of 0.6 mm and solvent-spun cellulose fibrillated to a fiber diameter of 0.5 μm and a fiber length of 1 mm were blended together in a proportion of 1:1 by mass ratio. These fibers were then placed in a different pulper from the aforementioned pulper in ion-exchange water at a density of 0.05% by mass, and were then dispersed for 30 minutes so as to prepare a fiber dispersion L.

The fiber dispersion K was made into sheet paper using a standard handsheet machine specified in JIS P8222 so that a wet paper sheet was obtained. The dispersion L was then layered on top of this sheet. Thereafter, the obtained wet paper sheet was removed from the handsheet machine, and a carboxymethyl cellulose aqueous solution was spray-coated thereon such that the coating amount when dry was 20 parts by mass relative to 100 parts by mass of the total dried fibers. Subsequently, the paper sheet was dried in a Yankee drier at 130° C. so that the separator of the present invention was obtained.

The properties of the obtained separator were as follows: a density of 0.40 g/cm³, a void ratio of 73%, and a separator thickness of 34 μm.

### Example 11

Polyethylene terephthalate fibers having a fiber diameter of 0.5 μm and a fiber length of 5 mm were placed in a pulper in ion-exchange water at a density of 0.05% by mass, and were dispersed for 30 minutes so as to prepare a fiber dispersion M. Next, aromatic polyamide fibrillated to a fiber diameter of 0.2 μm and a fiber length of 0.6 mm and solvent-spun cellulose fibrillated to a fiber diameter of 0.5 μm and a fiber length of 1 mm were blended together in a proportion of 1:1 by mass ratio, and were placed in a different pulper from the aforementioned pulper in ion-exchange water at a density of 0.05% by mass, and were then dispersed for 30 minutes so as to prepare a fiber dispersion N.

The fiber dispersion M was made into sheet paper using a standard handsheet machine specified in JIS P8222 so that a wet paper sheet was obtained. The dispersion N was then layered on top of this sheet. Thereafter, the obtained wet paper sheet was removed from the handsheet machine, and a carboxymethyl cellulose aqueous solution was spray-coated thereon such that the coating amount when dry was 20 parts by mass relative to 100 parts by mass of the total dried fibers. Subsequently, the paper sheet was dried in a Yankee drier at 130° C. so that the separator of the present invention was obtained.

The properties of the obtained separator were as follows: a density of 0.41 g/cm³, a void ratio of 73%, and a separator thickness of 29 μm.

### Example 12

Polyethylene terephthalate fibers having a fiber diameter of 2.5 μm and a fiber length of 6 mm were placed in a pulper in ion-exchange water at a density of 0.05% by mass, and were dispersed for 30 minutes so as to prepare a fiber dispersion P. Next, aromatic polyamide fibrillated to a fiber diameter of 0.2 μm and a fiber length of 0.6 mm and solvent-spun cellulose fibrillated to a fiber diameter of 0.5 μm and a fiber length of 1 mm were blended together in a proportion of 1:1 by mass ratio, and were placed in a different pulper from the aforementioned pulper in ion-exchange water at a density of 0.05% by mass, and were then dispersed for 30 minutes so as to prepare a fiber dispersion Q.

The fiber dispersion P was made into sheet paper using a standard handsheet machine specified in JIS P8222 so that a wet paper sheet was obtained. The dispersion Q was then layered on top of this sheet. Thereafter, the obtained wet paper sheet was removed from the handsheet machine, and a carboxymethyl cellulose aqueous solution was spray-coated thereon such that the coating amount when dry was 20 parts by mass relative to 100 parts by mass of the total dried fibers. Subsequently, the paper sheet was dried in a Yankee drier at 130° C. so that the separator of the present invention was obtained.

The properties of the obtained separator were as follows: a density of 0.41 g/cm³, a void ratio of 73%, and a separator thickness of 19 μm.

### Example 13

Polyethylene terephthalate fibers having a fiber diameter of 2.5 μm and a fiber length of 6 mm were placed in a pulper in ion-exchange water at a density of 0.05% by mass, and were dispersed for 30 minutes so as to prepare a fiber dispersion R. Next, aromatic polyamide fibrillated to a fiber diameter of 0.6 μm and a fiber length of 1.5 mm was placed in a pulper in ion-exchange water at a density of 0.05% by mass, and was dispersed for 30 minutes so as to prepare a fiber dispersion S. In addition, solvent-spun cellulose fibrillated to a fiber diameter of 0.5 μm and a fiber length of 1 mm was placed in a different pulper from the aforementioned pulper in ion-exchange water at a density of 0.05% by mass, and was then dispersed for 30 minutes so as to prepare a fiber dispersion T.

The fiber dispersion R was made into sheet paper using a standard handsheet machine specified in JIS P8222 so that a wet paper sheet was obtained. The dispersion S was then layered on top of this sheet. Thereafter, the dispersion T was then layered on top of the sheet. The obtained wet paper sheet was removed from the handsheet machine, and a carboxymethyl cellulose aqueous solution was spray-coated thereon such that the coating amount when dry was 20 parts by mass relative to 100 parts by mass of the total dried fibers. Subsequently, the paper sheet was dried in a Yankee drier at 130° C. so that the separator of the present invention was obtained.

The properties of the obtained separator were as follows: a density of 0.40 g/cm³, a void ratio of 73%, and a separator thickness of 35 μm.

### Example 14

Polyethylene terephthalate fibers having a fiber diameter of 2.5 μm and a fiber length of 6 mm, fibers formed from aromatic polyamide fibrillated to a fiber diameter of 0.2 μm and a fiber length of 0.6 mm, and fibers formed from solvent-spun cellulose fibrillated to a fiber diameter of 0.5 μm and a fiber length of 1 mm were placed in a pulper at mass percentages of 25:60:15 respectively in ion-exchange water at a density of 0.05% by mass, and were then dispersed for 30 minutes so as to prepare a fiber dispersion U.

The dispersion U was supplied to both the first flow box 14 and the second flow box 15 of the multi-tank tilting wet paper machine shown in FIG. 1. The traveling of the paper making net 10 was then started and the dispersion U was allowed to flow from the respective flow boxes onto the tilted travel portion 13. In this manner, a wet paper sheet was manufactured with fiber layers having the same fiber composition layered in sequence. A carboxymethyl cellulose aqueous solution was spray-coated thereon over felt such that the coating amount when dry was 20 parts by mass relative to 100 parts by mass of the total dried fibers. Subsequently, the paper sheet was dried in a Yankee drier at 130° C. so that a separator without any pinholes and having a thickness of 20 μm, a density of 0.45 g/cm³, and a void ratio of 70% was obtained.

### Example 15

Fibers formed from polyethylene terephthalate fibers having a fiber diameter of 2.5 μm and a fiber length of 6 mm were placed in a pulper in ion-exchange water at a density of 0.05% by mass, and were dispersed for 30 minutes so as to prepare a fiber dispersion V. Fibers formed from aromatic polyamide fibrillated to a fiber diameter of 0.2 μm and a fiber length of 0.6 mm and fibers formed from solvent-spun cellulose fibrillated to a fiber diameter of 0.5 μm and a fiber length of 1 mm were blended together in a proportion of 80:20 respectively by mass ratio, and were placed in the pulper in ion-exchange water at a density of 0.05% by mass, and were then dispersed for 30 minutes so as to prepare a fiber dispersion W.

The dispersion V was supplied to the first flow box 14, and the dispersion W was supplied to the second flow box 15 of the multi-tank tilting wet paper machine shown in FIG. 1. Next, the traveling of the paper making net 10 was started, and the dispersions were allowed to flow from the respective flow boxes onto the tilted travel portion 13. In this manner, a wet paper sheet was manufactured with fiber layers of different types of fiber layered in sequence. A carboxymethyl cellulose aqueous solution was spray-coated thereon over felt such that the coating amount when dry was 20 parts by mass relative to 100 parts by mass of the total dried fibers. Subsequently, the paper sheet was dried in a Yankee drier at 130° C. so that a separator without any pinholes and having a thickness of 20 μm, a density of 0.45 g/cm³, and a void ratio of 69%, and having different mutually different fiber types on the front and rear surfaces was obtained.

### Comparative Example 1

Polyethylene terephthalate fibers having a fiber diameter of 2.5 μm and a fiber length of 6 mm were placed in a pulper in ion-exchange water at a density of 0.05% by mass, and were dispersed for 30 minutes so as to prepare a fiber dispersion A. Next, aromatic polyamide fibrillated to a fiber diameter of 0.2 μm and a fiber length of 0.6 mm and solvent-spun cellulose fibrillated to a fiber diameter of 0.5 μm and a fiber length of 1 mm were blended together in a proportion of 1:1 by mass ratio. These fibers were placed in a different pulper from the aforementioned pulper in ion-exchange water at a density of 0.05% by mass, and were then dispersed for 30 minutes so as to prepare a fiber dispersion B.

The dispersion A was made into sheet paper using a standard handsheet machine specified in JIS P8222 so that a wet paper sheet was obtained. The dispersion B was then layered on top of this sheet. Thereafter, the obtained wet paper sheet was removed from the handsheet machine, and was dried in a Yankee drier at 130° C. so that a separator was obtained for comparison.

The properties of the obtained separator for comparison were as follows: a density of 0.40 g/cm³, a void ratio of 73%, and a separator thickness of 30 μm.

### Comparative Example 2

Solvent-spun cellulose which was not in the form of synthetic fibers fibrillated to a fiber diameter of 0.5 μm and a fiber length of 1 mm were placed in a pulper in ion-exchange water at a density of 0.05% by mass, and were dispersed for 30 minutes so as to prepare a fiber dispersion c.

The dispersion c was made into sheet paper using a standard handsheet machine specified in JIS P8222 so that a wet paper sheet having a basis weight of 6 g/cm² was obtained. The dispersion S was then layered on top of this sheet. Thereafter, the obtained wet paper sheet was removed from the handsheet machine, and a carboxymethyl cellulose aqueous solution was spray-coated thereon such that the coating amount when dry was 20 parts by mass relative to 100 parts by mass of the total dried fibers. Subsequently, the paper sheet was dried in a Yankee drier at 130° C. C so that a separator was obtained for comparison.

The properties of the obtained separator for comparison were as follows: a density of 0.41 g/cm³, a void ratio of 74%, and a separator thickness of 32 μm.

The following evaluations were performed for the separators obtained in Examples 1 to 15 and Comparative examples 1 and 2 so that their characteristics as separators could be evaluated. Note that physical properties, namely, the film thickness, density, and void ratio of each separator are shown in Table 1.

TABLE 1

| | Film thickness | Density | Void ratio |
|---|---|---|---|
| | (μm) | (g/cm³) | (%) |
| Example 1 | 30 | 0.40 | 73 |
| Example 2 | 32 | 0.43 | 75 |
| Example 3 | 30 | 0.40 | 73 |
| Example 4 | 33 | 0.52 | 70 |
| Example 5 | 35 | 0.55 | 69 |
| Example 6 | 30 | 0.40 | 73 |
| Example 7 | 30 | 0.39 | 74 |
| Example 8 | 31 | 0.44 | 74 |
| Example 9 | 29 | 0.42 | 73 |
| Example 10 | 34 | 0.40 | 73 |
| Example 11 | 29 | 0.41 | 73 |
| Example 12 | 19 | 0.40 | 73 |
| Example 13 | 35 | 0.40 | 73 |
| Example 14 | 20 | 0.45 | 70 |
| Example 15 | 20 | 0.45 | 69 |
| Comp. Example 1 | 30 | 0.40 | 73 |
| Comp. Example 2 | 32 | 0.41 | 74 |

### [Assembly of Electric Double-Layer Capacitors, and Evaluation of Discharge Capacity and Voltage Holding Ability]

Electrical double-layer capacitors were assembled using positive and negative electrodes for the separators of Examples 1 to 15 and Comparative examples 1 and 2, and 100 wound cells of each were manufactured. Note that during the manufacturing of the wound cells, active carbon electrodes (manufactured by Hohsen Corporation) for electrical double-layer capacitors were used for the electrodes. Furthermore, a solution obtained by dissolving tetraethylammonium tetrafluoroborate (manufactured by Kishida Chemical Co., Ltd.) in propylene carbonate to a quantity of 1 mol/L was used as the electrolyte solution.

The initial discharge capacity, the discharge capacity after 2000 hours of testing and the discharge capacity after 4000 hours of testing in each of the manufactured wound cells were measured using an LCR meter. In addition, each cell was charged with 2.5 volts after 2000 hours of testing, after which the electrical circuit was opened and the voltage holding ability after 24 hours was examined. Note that the test conditions were a temperature of 80° C. and a voltage application of 2.5V. The results obtained are shown in Table 2.

TABLE 2

| | Initial | Discharge | Discharge | Held |
|---|---|---|---|---|
| | discharge | capacity after | capacity after | voltage |
| | capacity (F) | 2000 hours (F) | 4000 hours (F) | (V) |
| Example 1 | 11.0 | 10.0 | 9.4 | 2.36 |
| Example 2 | 10.9 | 10.0 | 9.3 | 2.39 |
| Example 3 | 11.1 | 10.2 | 9.2 | 2.31 |
| Example 4 | 10.8 | 9.9 | 9.1 | 2.29 |
| Example 5 | 11.0 | 9.9 | 9.3 | 2.27 |
| Example 6 | 10.7 | 10.0 | 9.4 | 2.26 |
| Example 7 | 10.9 | 9.4 | 9.1 | 2.31 |
| Example 8 | 10.8 | 9.7 | 8.6 | 2.29 |
| Example 9 | 11.4 | 9.6 | 8.8 | 2.42 |
| Example 10 | 11.3 | 9.8 | 8.7 | 2.42 |
| Example 11 | 10.9 | 9.4 | 9.3 | 2.28 |
| Example 12 | 11.1 | 9.5 | 9.5 | 2.27 |
| Example 13 | 10.8 | 9.5 | 9.0 | 2.26 |
| Example 14 | 11.0 | 9.3 | 8.5 | 2.41 |
| Example 15 | 11.2 | 10.2 | 9.5 | 2.45 |
| Comp. | 10.0 | 9.0 | 7.4 | 2.36 |
| Example 1 | | | | |
| Comp. | 10.0 | 6.9 | 3.8 | 1.86 |
| Example 2 | | | | |

### [Comparison of Separator Crushing Strength]

The thicknesses of the separators of Examples 1 to 15 and Comparative examples 1 and 2 were measured after they were crushed at 170° C. at a pressure of 1N/cm². The results obtained are shown in Table 3.

TABLE 3

Film thickness (μm)

| | Initial | After crushing |
|---|---|---|
| Example 1 | 30 | 30 |
| Example 2 | 30 | 30 |
| Example 3 | 30 | 30 |
| Example 4 | 30 | 29 |
| Example 5 | 30 | 30 |
| Example 6 | 30 | 29 |
| Example 7 | 30 | 30 |
| Example 8 | 30 | 29 |
| Example 9 | 30 | 30 |
| Example 10 | 30 | 29 |
| Example 11 | 30 | 29 |
| Example 12 | 19 | 18 |
| Example 13 | 35 | 33 |
| Example 14 | 20 | 19 |
| Example 15 | 20 | 20 |
| Comp. Example 1 | 30 | 25 |
| Comp. Example 2 | 32 | 26 |

As is clear from the results shown in Tables 2 and 3, it was confirmed that electrical double-layer capacitors in which the separators of the present invention were used demonstrated superior properties. Namely, a satisfactory discharge capacity of 8.5 F or more was maintained even after 4000 hours of testing at 80° C. and at 2.5 V, a voltage of 2.26 V or more was held, and crushing strength values that were also very close to the initial values were maintained. In contrast to this, in the electrical double-layer capacitors in which the separators of Comparative examples 1 and 2 were used, there was a substantial reduction in discharge capacity and the electrical double-layer capacitors deteriorated markedly. Moreover, the separators of Comparative examples 1 and 2 showed a conspicuous reduction in film thickness in the crushing tests.

From the above results it was found that, in spite of being formed by a thin film, the separator of the present invention showed superb durability in a high-temperature environment in the presence of organic solvents and ionic liquids. Accordingly, the separator of the present invention can be favorably used as an electricity storage device such as an electrical double-layer capacitor, and is excellent in preventing short-circuiting between electrodes and in suppressing self-discharge.

### Example 16

Fibers A formed from polyethylene terephthalate fibers having a fiber diameter of 2.5 μm and a fiber length of 6 mm, fibers B formed from aromatic polyamide fibrillated to a fiber diameter of 0.2 μm and a fiber length of 0.6 mm, and fibers C formed from solvent-spun cellulose fibrillated to a fiber diameter of 0.5 μm and a fiber length of 1 mm were placed in a pulper at mass percentages of 25:60:15 respectively in ion-exchange water at a density of 0.05% by mass, and were then dispersed for 30 minutes so as to prepare a paper making material formed from a fiber dispersion.

This paper making material was made into a wet paper sheet (i.e., a fiber layer) using a standard handsheet machine specified in JIS P8222. Thereafter, the obtained wet paper sheet was removed from the handsheet machine, and a carboxymethyl cellulose aqueous solution was spray-coated thereon such that the coating amount when dry was 20 parts by mass relative to 100 parts by mass of the total dried fibers. Subsequently, the paper sheet was dried in a Yankee drier at 130° C. so that the separator of the present invention was obtained.

The properties of the obtained separator were as follows: a separator thickness of 31 μm, a density of 0.41 g/cm³, and an air permeability of 8 sec/100 ml.

### Example 17

Other than altering the carboxymethyl cellulose aqueous solution of Example 16 to an SBR aqueous emulsion, a separator of the present invention was prepared in the same way.

The properties of the obtained separator were as follows: a separator thickness of 31 μm, a density of 0.45 g/cm³, and an air permeability of 8 sec/100 ml.

### Example 18

Other than altering the spray-coat quantity after drying of the carboxymethyl cellulose aqueous solution of Example 16 to 10 parts by mass, a separator of the present invention was prepared in the same way.

The properties of the obtained separator were as follows: a separator thickness of 30 μm, a density of 0.40 g/cm³, and an air permeability of 12 sec/100 ml.

### Example 19

Other than altering the spray-coat quantity after drying of the carboxymethyl cellulose aqueous solution of Example 16 to 60 parts by mass, a separator of the present invention was prepared in the same way.

The properties of the obtained separator were as follows: a separator thickness of 33 μm, a density of 0.55 g/cm³, and an air permeability of 74 sec/100 ml.

### Example 20

Other than altering the spray-coat quantity after drying of the carboxymethyl cellulose aqueous solution of Example 16 to 150 parts by mass, a separator of the present invention was prepared in the same way.

The properties of the obtained separator were as follows: a separator thickness of 32 μm, a density of 0.63 g/cm³, and an air permeability of 82 sec/100 ml.

### Example 21

Fibers A formed from polyethylene terephthalate fibers having a fiber diameter of 2.5 μm and a fiber length of 6 mm, fibers B formed from aromatic polyamide fibrillated to a fiber diameter of 0.2 μm and a fiber length of 0.6 mm, and fibers C formed from solvent-spun cellulose fibrillated to a fiber diameter of 0.5 μm and a fiber length of 1 mm were placed in a pulper at mass percentages of 25:60:15 respectively in ion-exchange water at a density of 0.05% by mass, and were then dispersed for 30 minutes so as to prepare a paper making material formed from a fiber dispersion.

This paper making material was made into a wet paper sheet (i.e., a fiber layer) using a standard handsheet machine specified in JIS P8222. Thereafter, the obtained wet paper sheet was removed from the handsheet machine, and was dried in a Yankee drier at 130° C. Subsequently, a carboxymethyl cellulose aqueous solution was spray-coated on the paper sheet such that the coating amount when dry was 20 parts by mass relative to 100 parts by mass of the total dried fibers. The paper sheet was then dried in a Yankee drier at 130° C. so that the separator of the present invention was obtained.

The properties of the obtained separator were as follows: a separator thickness of 31 μm, a density of 0.41 g/cm³, and an air permeability of 8 sec/100 ml.

### Example 22

Fibers A formed from polyethylene terephthalate fibers having a fiber diameter of 3.2 μm and a fiber length of 6 mm, fibers B formed from aromatic polyamide fibrillated to a fiber diameter of 0.2 μm and a fiber length of 0.6 mm, and fibers C formed from solvent-spun cellulose fibrillated to a fiber diameter of 0.5 μm and a fiber length of 1 mm were placed in a pulper at mass percentages of 40:40:20 respectively in ion-exchange water at a density of 0.05% by mass, and were then dispersed for 30 minutes so as to prepare a paper making material formed from a fiber dispersion. Thereafter, the same type of sheet paper making, synthetic resin binding agent spray-coating and drying treatment as in Example 16 were performed so that the separator of the present invention was obtained.

The properties of the obtained separator were as follows: a separator thickness of 49 μm, a density of 0.32 g/cm³, and an air permeability of 15 sec/100 ml.

### Example 23

Fibers A formed from polyethylene terephthalate fibers having a fiber diameter of 2.5 μm and a fiber length of 6 mm, fibers B foamed from polyphenylene sulfide fibrillated to a fiber diameter of 0.8 μm and a fiber length of 1.5 mm, and fibers C formed from solvent-spun cellulose fibrillated to a fiber diameter of 0.5 μm and a fiber length of 1 mm were placed in a pulper at mass percentages of 30:30:40 respectively in ion-exchange water at a density of 0.05% by mass, and were then dispersed for 30 minutes so as to prepare a paper making material formed from a fiber dispersion. Thereafter, the same type of sheet paper making, synthetic resin binding agent spray-coating and drying treatment as in Example 16 were performed so that the separator of the present invention was obtained.

The properties of the obtained separator were as follows: a separator thickness of 22 μm, a density of 0.45 g/cm³, and an air permeability of 5 sec/100 ml.

### Example 24

Fibers A formed from polyethylene fibers having a fiber diameter of 3 μm and a fiber length of 6 mm, fibers B formed from aromatic polyamide fibrillated to a fiber diameter of 0.2 μm and a fiber length of 0.6 mm, and fibers C formed from solvent-spun cellulose fibrillated to a fiber diameter of 0.5 μm and a fiber length of 1 mm were placed in a pulper at mass percentages of 50:30:20 respectively in ion-exchange water at a density of 0.05% by mass, and were then dispersed for 30 minutes so as to prepare a paper making material formed from a fiber dispersion. Thereafter, the same type of sheet paper making, synthetic resin binding agent spray-coating and drying treatment as in Example 16 were performed so that the separator of the present invention was obtained.

The properties of the obtained separator were as follows: a separator thickness of 57 μm, a density of 0.36 g/cm³, and an air permeability of 19 sec/100 ml.

### Example 25

Fibers A formed from polyethylene fibers having a fiber diameter of 3 μm and a fiber length of 6 mm, fibers B formed from aromatic polyester fibrillated to a fiber diameter of 0.4 μm and a fiber length of 1 mm, and fibers C formed from solvent-spun cellulose fibrillated to a fiber diameter of 0.5 μm and a fiber length of 1 mm were placed in a pulper at mass percentages of 25:60:15 respectively in ion-exchange water at a density of 0.05% by mass, and were then dispersed for 30 minutes so as to prepare a paper making material formed from a fiber dispersion. Thereafter, the same type of sheet paper making, synthetic resin binding agent spray-coating and drying treatment as in Example 16 were performed so that the separator of the present invention was obtained.

The properties of the obtained separator were as follows: a separator thickness of 32 μm, a density of 0.45 g/cm³, and an air permeability of 11 sec/100 ml.

### Example 26

Fibers A formed from polyethylene terephthalate fibers having a fiber diameter of 2.5 μm and a fiber length of 6 mm, fibers B formed from polyparaphenylene benzobisoxazole fibrillated to a fiber diameter of 0.3 μm and a fiber length of 1 mm, and fibers C formed from solvent-spun cellulose fibrillated to a fiber diameter of 0.5 μm and a fiber length of 1 mm were placed in a pulper at mass percentages of 25:50:25 respectively in ion-exchange water at a density of 0.05% by mass, and were then dispersed for 30 minutes so as to prepare a paper making material formed from a fiber dispersion. Thereafter, the same type of sheet paper making, synthetic resin binding agent spray-coating and drying treatment as in Example 16 were performed so that the separator of the present invention was obtained.

The properties of the obtained separator were as follows: a separator thickness of 38 μm, a density of 0.62 g/cm³, and an air permeability of 42 sec/100 ml.

### Comparative Example 3

Fibers A formed from polyethylene terephthalate fibers having a fiber diameter of 2.5 μm and a fiber length of 6 mm, fibers B formed from aromatic polyamide fibrillated to a fiber diameter of 0.2 μm and a fiber length of 0.6 mm, and fibers C formed from solvent-spun cellulose fibrillated to a fiber diameter of 0.5 μm and a fiber length of 1 mm were placed in a pulper at mass percentages of 25:60:15 respectively in ion-exchange water at a density of 0.05% by mass, and were then dispersed for 30 minutes so as to prepare a paper making material formed from a fiber dispersion.

This paper making material was made into a wet paper sheet using a standard handsheet machine specified in JIS P8222. Thereafter, the obtained wet paper sheet was removed from the handsheet machine, and was dried in a Yankee drier at 130° C. without undergoing any further processing so that a separator for comparison was obtained.

The properties of the obtained separator were as follows: a separator thickness of 30 μm, a density of 0.41 g/cm³, and an air permeability of 8 sec/100 ml.

### Comparative Example 4

Fibers C formed from solvent-spun cellulose fibrillated to a fiber diameter of 0.5 μm and a fiber length of 1 mm were placed in a pulper in ion-exchange water at a density of 0.05% by mass, and were then dispersed for 30 minutes so as to prepare a paper making material formed from a fiber dispersion. Thereafter, the same type of sheet paper making, synthetic resin binding agent spray-coating and drying treatment as in Example 16 were performed so that a separator for comparison was obtained.

The properties of the obtained separator were as follows: a separator thickness of 35 μm, a density of 0.41 g/cm³, and an air permeability of 5 sec/100 ml.

### Comparative Example 5

Fibers A formed from polyethylene terephthalate fibers having a fiber diameter of 2.5 μm and a fiber length of 6 mm and fibers C formed from solvent-spun cellulose fibrillated to a fiber diameter of 0.5 μm and a fiber length of 1 mm were placed in a pulper at mass percentages of 80:20 respectively in ion-exchange water at a density of 0.05% by mass, and were then dispersed for 30 minutes so as to prepare a paper making material formed from a fiber dispersion. Thereafter, the same type of sheet paper making, synthetic resin binding agent spray-coating and drying treatment as in Example 16 were performed so that a separator for comparison was obtained.

The properties of the obtained separator were as follows: a separator thickness of 70 μM, a density of 0.32 g/cm³, and an air permeability of 39 sec/100 ml.

The following evaluations were performed for the separators obtained in Examples 16 to 26 and Comparative examples 3 to 5 so that their characteristics as separators for electricity could be evaluated. Note that physical properties, namely, the blend proportion of the fibers, thickness, density, and air permeability of each separator are shown in Table 4.

TABLE 4

| | Blend proportion (mass %) | | | Resin content | | | Air |
|---|---|---|---|---|---|---|---|
| | Fibers | Fibers | Fibers | (parts by | Thickness | Density | permeability |
| | A | B | C | mass) | (μm) | (g/cm³) | (sec/100 ml) |
| Example 16 | 25 | 60 | 15 | 20 | 31 | 0.41 | 8 |
| Example 17 | 25 | 60 | 15 | 20 | 31 | 0.45 | 8 |
| Example 18 | 25 | 60 | 15 | 10 | 30 | 0.40 | 12 |
| Example 19 | 25 | 60 | 15 | 60 | 33 | 0.55 | 74 |
| Example 20 | 25 | 60 | 15 | 150 | 32 | 0.63 | 82 |
| Example 21 | 25 | 60 | 15 | 20 | 31 | 0.41 | 8 |
| Example 22 | 40 | 40 | 20 | 20 | 49 | 0.32 | 15 |
| Example 23 | 30 | 30 | 40 | 20 | 22 | 0.45 | 5 |
| Example 24 | 50 | 30 | 20 | 20 | 57 | 0.36 | 19 |
| Example 25 | 25 | 60 | 15 | 20 | 32 | 0.45 | 11 |
| Example 26 | 25 | 50 | 25 | 20 | 38 | 0.62 | 42 |
| Comp. ex. 3 | 25 | 60 | 15 | — | 30 | 0.41 | 8 |
| Comp. ex. 4 | — | — | 100 | 20 | 35 | 0.41 | 5 |
| Comp. ex. 5 | 80 | — | 20 | 20 | 70 | 0.32 | 39 |

### [Assembly of Electric Double-Layer Capacitors, and Evaluation of Changes in Discharge Capacity During Prolonged High-Temperature Tests]

Electrical double-layer capacitors were assembled using positive and negative electrodes for the separators of Examples 16 to 26 and Comparative examples 3 to 5, and 100 wound cells of each were manufactured. Note that during the manufacturing of the wound cells, active carbon electrodes (manufactured by Hohsen Corporation) for electrical double-layer capacitors were used for the electrodes. Furthermore, a solution obtained by dissolving tetraethylammonium tetrafluoroborate (manufactured by Kishida Chemical Co., Ltd.) in propylene carbonate to a quantity of 1 mol/L was used as the electrolyte solution.

The initial discharge capacity, the discharge capacity after 2000 hours of testing and the discharge capacity after 4000 hours of testing in each of the manufactured wound cells were measured using an LCR meter. In addition, changes (i.e., the reduction) in the discharge capacity after prolonged use at high temperatures were evaluated. Note that the test conditions were a temperature of 80° C. and a voltage application of 2.5V. The results obtained are shown in Table 5.

TABLE 5

| | Discharge capacity (F) | | |
|---|---|---|---|
| | Initial | After 2000 hours | After 4000 hours |
| Example 16 | 10.8 | 10.5 | 10.2 |
| Example 17 | 10.7 | 10.5 | 10.3 |
| Example 18 | 10.7 | 10.6 | 10.2 |
| Example 19 | 11.0 | 10.6 | 10.4 |
| Example 20 | 11.2 | 10.8 | 10.1 |
| Example 21 | 10.9 | 10.4 | 9.9 |
| Example 22 | 11.2 | 10.8 | 10.2 |
| Example 23 | 10.9 | 10.4 | 9.8 |
| Example 24 | 11.0 | 10.5 | 10.0 |
| Example 25 | 11.1 | 10.9 | 10.7 |
| Example 26 | 11.4 | 11.1 | 10.7 |
| Comp. Ex. 3 | 9.8 | 9.5 | 9.2 |
| Comp. Ex. 4 | 10.0 | 8.8 | 7.5 |
| Comp. Ex. 5 | 10.2 | 9.2 | Internal |
| | | | short-circuiting |

As is clear from the results shown in Table 5, it was confirmed that electrical double-layer capacitors in which the separators of the present invention were used maintained a satisfactory discharge capacity of 9.8 F or more even after 4000 hours of a voltage application test of 2.5 V at 80° C. In contrast to this, in the electrical double-layer capacitors in which the separators of Comparative examples 3 to 5 were used, there was a substantial reduction in discharge capacity and the characteristics shows a marked deterioration.

### [Comparison of Separator Crushing Strength]

The thicknesses of the separators of Examples 16 to 26 and Comparative examples 3 to 5 were measured after they were crushed at 170° C. at a pressure of 1N/cm². The results obtained are shown in Table 6.

TABLE 6

Film thickness (μm)

| | Initial | After crushing |
|---|---|---|
| Example 16 | 31 | 30 |
| Example 17 | 31 | 30 |
| Example 18 | 31 | 30 |
| Example 19 | 31 | 31 |
| Example 20 | 31 | 30 |
| Example 21 | 31 | 31 |
| Example 22 | 49 | 47 |
| Example 23 | 22 | 21 |
| Example 24 | 57 | 56 |
| Example 25 | 32 | 30 |
| Example 26 | 38 | 36 |
| Comp. Example 3 | 30 | 25 |
| Comp. Example 4 | 35 | 27 |
| Comp. Example 5 | 70 | 55 |

As is clear from the results shown in Table 6, it was confirmed that electrical double-layer capacitors in which the separators of the present invention were used demonstrated superior properties, namely, crushing strength values that were very close to the initial values were maintained. In contrast to this, in the electrical double-layer capacitors in which the separators of Comparative examples 3 to 5 were used, there was a conspicuous reduction in film thickness in the crushing tests.

From the above results it was found that, in spite of being formed by a thin film, the separator of the present invention showed superb durability in a high-temperature environment in the presence of organic solvents and ionic liquids. Accordingly, the separator of the present invention can be favorably used as an electricity storage device such as an electrical double-layer capacitor, and is excellent in preventing short-circuiting between electrodes and in suppressing self-discharge.

### INDUSTRIAL APPLICABILITY

The separator of the present invention is formed as a thin film having heat-resistance, mechanical strength, and dimensional stability, and has superior ion permeation and low resistance, and, moreover, is excellent in suppressing short-circuiting between electrodes and self-discharge, and, furthermore, has superior durability even after prolonged use in a high-temperature environment in the presence of organic solvents and ionic liquids.

Accordingly, the separator of the present invention can be favorably used as an electricity storage device, and particularly, in lithium-ion secondary batteries, polymer-lithium secondary batteries, electric double-layer capacitors, or aluminum electrolytic capacitors, and is thus beneficial from an industrial standpoint.

### DESCRIPTION OF THE REFERENCE NUMERALS

10 Paper making net
11 Guide roller
12 Guide roller
13 Tilt travel portion
14 First flow box
15 Second flow box
16 Dispersion
17 Dispersion
18 Partition wall

1. A separator for an electricity storage device that is formed by superimposing two or more fiber layers, wherein at least one or more of the fiber layers is a synthetic fiber layer that contains synthetic fibers and a synthetic resin-based binding agent.

2. The separator for an electricity storage device according to claim 1, wherein the synthetic resin-based binding agent includes at least one type selected from a group made up of carboxymethyl cellulose and styrene-butadiene rubber.

3. The separator for an electricity storage device according to claim 1, wherein the synthetic resin-based binding agent is melted by heat treatment.

4. The separator for an electricity storage device according to claim 1, wherein the synthetic fibers include at least one type selected from a group made up of polyethylene terephthalate, polybutylene terephthalate, aromatic polyamide, aromatic polyester, semi-aromatic polyamide, polyphenylene sulfide, polyparaphenylene benzobisoxazole, polyethylene, polypropylene, aramid, and polyalylate.

5. The separator for an electricity storage device according to claim 1, wherein the fiber diameter of the synthetic fibers is 5 μm or less, and the fiber length of the synthetic fibers is 10 mm or less.

6. The separator for an electricity storage device according to claim 1, wherein the two or more fiber layers are layered one on top of the other on a paper making net using a tilted wire paper making machine having two or more heads.

7. The separator for an electricity storage device according to claim 1, wherein the two or more fiber layers are formed by using a multi-tank tilting wet paper machine that has a structure in which the bottom portion of a second flow box is positioned in the vicinity of an intersecting portion between a paper making net and a waterline inside a first flow box, and that is able to simultaneously form a plurality of layers, and by layering the two or more fiber layers together one on top of the other on the paper making net.

8. The separator for an electricity storage device according to claim 1, wherein the electricity storage device is any one of a lithium-ion secondary battery, a polymer-lithium secondary battery, an electric double-layer capacitor, and an aluminum electrolytic capacitor.

9. A method of manufacturing a separator for an electricity storage device that includes a step in which the separator for an electricity storage device according to any one of claims 1 through 8 is obtained by performing spray-coating so as to coat a synthetic resin-based binding agent onto fiber layers in a dry state or fiber layers in a wet state.

10. A separator for an electricity storage device that contains thermoplastic synthetic fibers A, heat-resistant synthetic fibers B, natural fibers C, and a synthetic resin-based binding agent.

11. The separator for an electricity storage device according to claim 10, wherein the synthetic resin-based binding agent includes at least one type selected from a group made up of carboxymethyl cellulose and styrene-butadiene rubber.

12. The separator for an electricity storage device according to claim 10, wherein the synthetic resin-based binding agent is melted by heat treatment.

13. The separator for an electricity storage device according to claim 10, wherein the thermoplastic synthetic fibers A include at least one type selected from a group made up of polyethylene terephthalate, polybutylene terephthalate, aromatic polyalylate, polyethylene, and polypropylene.

14. The separator for an electricity storage device according to claim 10, wherein the heat-resistant synthetic fibers B include at least one type selected from a group made up of aromatic polyamide, aromatic polyester, semi-aromatic polyamide, polyphenylene sulfide, and polyparaphenylene benzobisoxazole.

15. The separator for an electricity storage device according to claim 10, wherein the thermoplastic synthetic fibers A, the heat-resistant synthetic fibers B, and the natural fibers C are in respective blend proportions of 25 to 50 percent by mass, 60 to 10 percent by mass, and 15 to 40 percent by mass.

16. The separator for an electricity storage device according to claim 10, wherein the fiber diameter of the thermoplastic synthetic fibers A is 5 μm or less, and the fiber length of the thermoplastic synthetic fibers A is 10 mm or less.

17. The separator for an electricity storage device according to claim 10, wherein the fiber diameter of the heat-resistant synthetic fibers B is 1 μm or less, and the fiber length of the heat-resistant synthetic fibers B is fibrillated to 10 mm or less.

18. The separator for an electricity storage device according to claim 10, wherein the natural fibers C are solvent-spun cellulose that has been fibrillated to a fiber diameter of 1 μm or less, and a fiber length of 3 mm or less.

19. The separator for an electricity storage device according to claim 10, wherein
the heat-resistant synthetic fibers B and the natural fibers C are fibrillated, and
are formed by being interleaved with at least one type of fiber selected from a group made up of the thermoplastic synthetic fibers A, the fibrillated heat-resistant fibers B, and the fibrillated natural fibers C.

20. The separator for an electricity storage device according to claim 10, wherein the film thickness of the separator for an electricity storage device is 60 μm or less.

21. The separator for an electricity storage device according to claim 10, wherein the density of the separator for an electricity storage device is between 0.2 and 0.7 g/cm³.

22. The separator for an electricity storage device according to claim 10, wherein the air permeability of the separator for an electricity storage device is 100 sec/100 ml or less.

23. The separator for an electricity storage device according to claim 10, wherein the electricity storage device is any one of a lithium-ion secondary battery, a polymer-lithium secondary battery, an electric double-layer capacitor, and an aluminum electrolytic capacitor.

24. A method of manufacturing a separator for an electricity storage device that includes a step in which the separator for an electricity storage device according to any one of claims 10 through 23 is obtained by performing spray-coating so as to coat a synthetic resin-based binding agent onto fiber layers in a dry state or fiber layers in a wet state.
